(19) United States
(12) Patent Application Publication
(10) Pub. No.: US 2006/0042337 A1
(43) Pub. Date: Mar. 2, 2006

(54) Anti-theft door handle lock

(76) Inventor: Frank Su, Taipei (TW)

Correspondence Address: Frank Su, P. O. Box 55-846, Taipei, 104, TW

(21) Appl. No.: 10/929,703

(22) Filed: Aug. 31, 2004

(51) Int. Cl. E05B 13/10

(52) U.S. Cl. 70/472; 70/224

(57) ABSTRACT

A door handle lock includes a coupling member resiliently coupling an outer knob (or outer handle) with an outer shaft rotatably secured in an outer escutcheon fastened on an outside surface of a door; and a cam rotatably defined within the coupling member and secured on a spindle which is axially connected between the outer knob and an inner knob fastened to an inside surface of the door for operatively unlocking a latch normally protruding to be locked into a door frame, whereby upon a rotation of the spindle to allow the cam to retard a centripetal depression of the coupling through an access hole formed in the outer knob to prevent from decoupling of the outer knob from the outer shaft to enhance the security of a door handle; while upon an angular rotation of the spindle to bias the cam to allow a centripetal depression of the coupling, the outer knob will be decoupled and detached from the outer shaft for an easy maintenance or assembly of the door handle lock.

### BACKGROUND OF THE INVENTION

A conventional door lock and handle may be formed with a small hole through an outside knob (or outside handle) and an outside shaft rotatably mounted in an escutcheon in order that a tiny tool may be inserted into the small hole for decoupling or detaching the outside knob (or handle) from the shaft for maintenance or assembly purpose. However, such a small hole may also render an unexpected opportunity for a thief or intruder who may use a tool to dismantle the knob from the shaft. It would then be easily accessible into the locking mechanism of the door lock, to thereby unlock the door lock for his intrusion or theft purpose.

The present inventor has found the drawbacks of conventional door lock and handle, and invented the present anti-theft door handle lock.

### SUMMARY OF THE INVENTION

The object of the present invention is to provide a door handle lock including a coupling member resiliently coupling an outer knob (or outer handle) with an outer shaft rotatably secured in an outer escutcheon fastened on an outside surface of a door; and a cam rotatably defined within the coupling member and secured on a spindle which is axially connected between the outer knob and an inner knob fastened to an inside surface of the door for operatively unlocking a latch normally protruding to be locked into a door frame, whereby upon a rotation of the spindle to allow the cam to retard a centripetal depression of the coupling through an access hole formed in the outer knob to prevent from decoupling of the outer knob from the outer shaft to thereby enhance the security of a door handle; while upon an angular rotation of the spindle to bias the cam to allow a centripetal depression of the coupling, the outer knob will be decoupled and detached from the outer shaft for an easy maintenance or assembly of the door handle lock.

### BRIEF DESCRIPTION OF THE DRAWINGS

FIG. 1 is a sectional drawing of the present invention.

FIG. 2 is a cross sectional drawing as viewed from 2-2 direction of FIG. 1.

FIG. 3 is a sectional illustration showing that the coupling is depressible for decoupling the knob from the shaft when the door lock is unlocked.

FIG. 4 shows the coupling is retarded and not depressible when the door lock is locked.

FIG. 5 is an illustration showing the outer and inner knobs in accordance with the present invention.

### DETAILED DESCRIPTION

As shown in the drawing figures, the present invention is provided in a door handle lock or door lock comprising: an outer knob 1 (or outer handle) circumferentially disposed about and secured on a sleeve 2; a key-operated lock core 10 formed in the outer knob 1 and the sleeve 2; an outer shaft 3 resiliently coupled with the sleeve 2 by a control means 4; a spindle 5 axially linked between the outer knob 1 and an inner knob (or inner handle) 7 to be operatively rotated for retracting a latch 9 normally resiliently protruding to be locked into a door frame; an outer escutcheon 6 and an inner escutcheon 8 respectively disposed on and fastened (by bolts B) on an outside and inside surface of a door D, having the outer shaft 3 and an inner shaft 71 respectively rotatably mounted in the outer escutcheon 6 and the inner escutcheon 8.

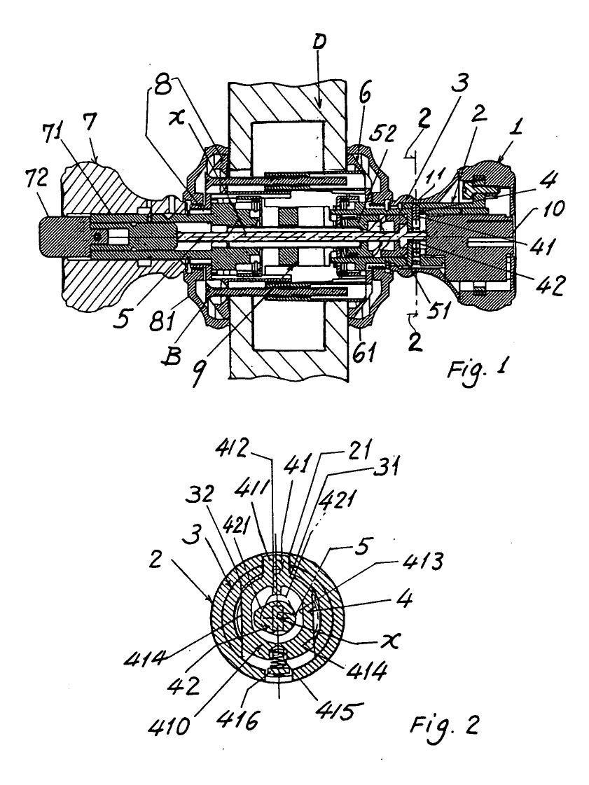

An outer cap 61 is provided for covering the outer escutcheon 6, while an inner cap 81 provided for covering the inner escutcheon 8 as shown in FIG. 1.

The spindle 5 has its inner end secured to an inner actuator 72 formed in the inner shaft 71, and an outermost end 50 of the spindle 5 secured to the key-operated lock core 10 formed in the outer knob 1 and in the sleeve 3.

The drawing figures attached herewith show the door knobs 1, 7 which are provided for use in the cylindrical door lock. However, the door knobs 1, 7 may also be replaced with lever handles, not limited in this invention. The locking and unlocking mechanism is as usual as the conventional door locks. Nevertheless, the locking or unlocking operation for this invention is still described hereinafter.

When it is intended to lock the door lock, the inner actuator 72 is operated to rotate the spindle 5 and to drive an inner clutch member 52 to be engaged with an outer clutch member 51 as shown in FIG. 4 to allow the inner clutch member 52 to be retained or locked in the outer escutcheon 6 by a conventional engaging and disengaging mechanism (which is so conventional and is not described in detail herewith). By the way, a rotation of the outer knob 1 trying to retract the latch 9 for unlocking the door lock will be prevented.

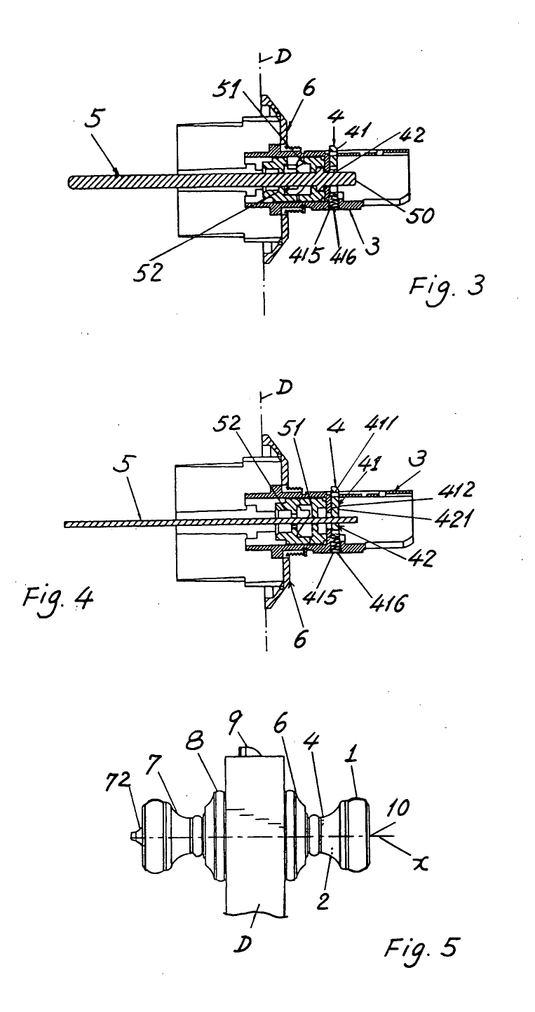

After inserting a key (not shown) into the lock core 10 in the outer knob 1 or by actuating the inner knob 7 to allow the outer clutch member 51 to uncouple the inner clutch member 52 as shown in FIG. 3 to unlock the inner clutch member 52 from the outer escutcheon 6, either outer knob 1 or inner knob 7 will then be free rotated for retracting the latch for unlocking the door lock.

The essential or characteristic mechanism of the present invention is the control means 4 which is provided for coupling the sleeve (or outer sleeve) 2 with the outer shaft (or outer tubular shaft) 3, or for decoupling the sleeve 2 from the shaft 3.

The control means 4, especially as shown in FIG. 2, includes: a coupling 41 for normally coupling the sleeve 2 and the outer shaft 3; and a cam 42 having its central portion secured with the spindle 5 and rotatably defined within the coupling 41.

The coupling 41 includes: a ring member 410, a depression projection 411 protruding radially from the ring member 410 through a shaft hole 31 formed through the outer shaft 3 and through a sleeve hole 21 formed through the sleeve 2 with the sleeve hole 21 communicated with an access hole 11 formed in the outer knob 1 (FIG. 1), an engaging lug 412 protruding centripetally from the ring member 410 to be engaged with a cam protrusion 421 of the cam 4 when the door lock is locked, a ring hole 413 formed in the ring member 410 allowing a rotation of the cam 42 within the ring hole 413, a pair of flat side portions 414 parallelly formed on opposite sides of the ring member 410 to be slidably engaged with a slot 32 formed in the shaft 3, a tension spring 415 retaining a bottom portion of the ring member 410 by a retainer 416 secured in the shaft 3 for resiliently urging the ring member 410 and the depression projection 411 radially (upwardly) for normally coupling the sleeve 2 with the shaft 3 especially as shown in FIG. 2.

The cam 42 includes a cam protrusion 421 eccentrically formed on the cam 42 about an axis X longitudinally formed in a longitudinal center of the spindle 5, with the cam protrusion 421 normally engaged with the engaging lug 412 of the coupling 41 when the door lock is locked or the cam protrusion 421 being operatively biased to be disengaged from the engaging lug 412 of the coupling 41 allowing a centripetal depression of the depression projection 411 of the coupling 41 to decouple the sleeve 2 from the shaft 3 when the door lock is unlocked. Since the outer knob (or handle) 1 is connected with the sleeve 2, the outer knob 1 and sleeve 2 will then be easily detached from the shaft 3 for maintenance or assembly.

The outer knob 1 and the sleeve 2 as well as the shaft 3 may be quickly installed on an outside surface of the door D to thereby facilitate the assembly or maintenance of a door handle lock.

Only upon unlocking of the door lock as solid line shown in FIG. 2 to rotate the spindle 5 and the cam 42 to disengage the protrusion 421 from the lug 412, the coupling 41 may be downwardly (centripetally) depressed to decouple the sleeve 2 from the shaft 3. In other words, when the door lock is locked by rotating the spindle 5 and the cam 42 to be at the locking state of the door lock, the engaging lug 412 of the coupling 41 is retarded by the cam protrusion 421 of the cam 42 as shown in FIG. 4 and the dotted line as shown in FIG. 2. If an intruder tries to depress the projection 411 of the coupling 41 by a tool through an access hole 11 formed in the outer knob 1 in order to decouple the sleeve 2 from the shaft 3, the coupling 41 will not be centripetally depressed as retarded by the cam 42. Therefore, it is safe to prevent from decoupling of the parts of the door knob or handle from outside of the door.

Only after unlocking the door lock by rotating the spindle 5 to rotate the cam 4 such as from FIG. 4 to FIG. 3 to disengage the cam protrusion 421 from the lug 412 of the coupling for allowing a downward (centripetal) depression of the coupling 41, the sleeve 2 will then be possibly decoupled from the shaft 3.

Accordingly, the present invention provides a security mechanism for safely preventing from decoupling of the outer door knob from outside a door by an intruder since the outer knob will not be detached when the door lock is locked. However, when the door lock is unlocked, the outer knob and other elements of the door handle lock will then be easily dismantled from outside the door for a convenient maintenance or assembly of the door handle lock device.

The present invention may be further modified without departing from the spirit and scope of the present invention.

I claim:

1. A door handle lock comprising:
an outer knob circumferentially disposed about and connected with a sleeve, an outer shaft disposed in and coupled with said sleeve by a control means, an outer escutcheon fastened on an outside surface of a door for rotatably mounting the outer shaft therein, a spindle axially connected between the outer knob and an inner knob formed in an inner escutcheon secured on an inside surface of the door for operatively retracting a latch for unlocking the door handle lock, and a lock core formed in said outer knob;
the improvement which comprises: said control means including:
a coupling normally coupling the sleeve and the outer shaft; and
a cam having a central portion of said cam secured with the spindle and rotatably defined within the coupling;
said coupling including: a ring member, a depression projection protruding radially from the ring member through a shaft hole formed through the outer shaft and through a sleeve hole formed through the sleeve with the sleeve hole communicated with an access hole formed in the outer knob, an engaging lug protruding centripetally from the ring member to be engaged with a cam protrusion of the cam when the door lock is locked, a ring hole formed in the ring member allowing a rotation of the cam within the ring hole, a pair of flat side portions parallelly formed on opposite sides of the ring member to be slidably engaged with a slot formed in the shaft, a tension spring retaining a bottom portion of the ring member by a retainer secured in the shaft for resiliently urging the ring member and the depression projection radially for normally coupling the sleeve with the shaft; and
said cam including: said cam protrusion eccentrically formed on the cam about an axis longitudinally formed in a longitudinal center of said spindle; with the cam protrusion normally engaged with the engaging lug of the coupling when the door lock is locked; or the cam protrusion operatively biased to be disengaged from the engaging lug of the coupling for allowing a centripetal depression of the depression projection of the coupling to decouple the sleeve from the shaft when the door lock is unlocked.
